(19) United States
(12) Patent Application Publication
(10) Pub. No.: US 2022/0383210 A1
(43) Pub. Date: Dec. 1, 2022

(54) Automated Package Generation Based On Conditional Commands

(71) Applicant: Lifeblue, Inc., Plano, TX (US)

(72) Inventors: Phillip Blackmon, Plano, TX (US); Jordan Savant, Plano, TX (US); Derek Odell, Plano, TX (US); Jean Wallace, Plano, TX (US)

(21) Appl. No.: 17/826,745

(22) Filed: May 27, 2022

Related U.S. Application Data
(60) Provisional application No. 63/194,755, filed on May 28, 2021.

(51) Int. Cl. G06Q 10/02; G06F 9/30

(52) U.S. Cl. CPC G06Q 10/02; G06F 9/30029

(57) ABSTRACT

Disclosed is a mechanism implemented by a server. The mechanism comprises receiving a plurality of data points. Indications of logical operators, the plurality of data points, and function calls are transmitted to an administrator. Conditional commands describing event packages are received from the administrator. The conditional commands include correlations between the logical operators, the data points, and the function calls. The conditional commands are executed to build the event packages based on user information.

### CROSS-REFERENCE TO RELATED APPLICATIONS

This patent application claims the benefit of U.S. Provisional Patent Application No. 63/194,755, filed May 28, 2021 by Phillip Blackmon, et al., and titled “Integrated Benefit Management System For Venue Passes Housed on Multiple Sub-systems,” which is hereby incorporated by reference.

### BACKGROUND

Data relating to events is generally stored as discrete units that are uncorrelated. As a result, an individual wishing to attend an event can often obtain access to a single event. However, the user may be unaware of how event data is correlated. Further, any data that would hint at correlations between event data is obscured from the end user. As such, the user may be unable to obtain access to correlated events and items related to such events without human interaction.

### SUMMARY

In an embodiment, the disclosure includes a method implemented by server, the method comprising: receiving a plurality of data points; transmitting indications of logical operators, the plurality of data points, and function calls to an administrator; receiving conditional commands describing event packages from the administrator, the conditional commands including correlations between the logical operators, the data points, and the function calls; and executing the conditional commands to build the event packages based on user information.

In another embodiment, the disclosure includes a server comprising: a transmitter configured to transmit indications of logical operators, a plurality of data points, and function calls to an administrator; a receiver configured to: receive the plurality of data points; and receive conditional commands describing event packages from the administrator, the conditional commands including correlations between the logical operators, the data points, and the function calls; and a processor coupled to the transmitter and receiver, the processor configured to execute the conditional commands to build the event packages based on user information.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example network configured to support automated generation of event packages based on conditional commands.

FIG. 2 is a schematic diagram of an example method of generating conditional commands to support package generation.

FIGS. 3A-3B are a schematic diagram of an example method of generating packages based on conditional commands.

FIG. 4 is a schematic diagram of server configured to generate packages based on conditional commands.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In some example systems, event data is stored in a manner that is largely uncorrelated from a user's perspective. For example, events may be associated with various allocable resources. Such allocable resources may include events, benefits associated with the events, and admission areas such as seats, zones, etc. For example, a user can obtain access to an admission area at a single event. If the user wishes to attend multiple events, the user must obtain access to each event as part of a separate allocation. As such, the user may be unable to obtain a consistent experience across multiple events and may not get any synergistic benefits for obtaining access to multiple events. In another example, a user can obtain access to a specific admission area for an entire season of events. If the user wishes to attend less than an entire season, the user must dispose of unwanted events without assistance from the event system. For example, the user can allow such events to go unused or transfer event access to others without help from the event system. However, the user may be unable to obtain allocable event resources in a manner that is customized based on the user's preferences.

Disclosed herein is a system that employs conditional commands to automatically indicate correlations between various venue data and generate a user specific event package based on user interaction. For example, the system may allow administrators to build conditional commands to indicate data correlations to an end user. The system may obtain static data points indicating allocable event resources and dynamic data points indicating user states. The system may then provide logical operators, data points, and function calls to the administrator to allow the administrator to create the conditional commands to generate the event packages. For example, the conditional commands may lock access to a high priority event until a user has selected a number of lower priority events exceeding a threshold. In another example, the conditional commands may lock access to higher priority benefits until a user has selected a number of events and/or lower priority benefits exceeding corresponding threshold. In another example, the conditional commands may allow a user to obtain access to admission areas in an aggregated manner across multiple events, for example by obtaining access to lower priority admission areas at some events and higher priority admission areas in other events so long as an aggregate admission area value remains below a threshold. Further, the conditional commands suggest upgrades to a first allocable event resource (e.g., an increased benefit or increased admission area) that can be automatically obtained in conjunction with an upgrade to a second allocable event resource (e.g., an increased number of events).

These examples can be accomplished based on user interaction. For example, the system can receive an initial user interest (e.g., indicating a first event), query venue data based on the initial user interest, and return a list of suggested events based on the initial user interest (e.g., additional events related to the first event). The user can then select a list of events. The conditional commands can continuously provide additional event suggestions based on the user's decision to add and/or remove events. The system can also query benefit data and return a list of suggested benefits based on the event selection. For example, the benefits may include physical items (e.g., team jerseys, food, drinks, etc.), digital items (e.g., downloads), and access to bonus experiences (e.g., parties). The user can select a list of benefits. The conditional commands can continuously provide additional benefit suggestions based on the user's decision to add and/or remove benefits. The conditional commands can also provide additional benefit suggestions that can be obtained based on changes to the event selection. The system can also query and return available admission areas (e.g., seats, seating sections, etc.) based on benefit selection and/or event selection. The user can select a list of seats for the selected events. The conditional commands can also provide additional admission area suggestions that can be obtained based on changes to the event selection and/or benefit selection. The system can provide a visualization of the available admission areas. Further, the system can employ metadata related to the admission areas and provide a visualization of such metadata, for example by illustrating handicap friendly areas, areas with less obstructed views, areas with easier access to amenities, etc. The system can then contact an event management system to allocate the selected events, benefits, and admission areas (e.g., individually) and return such items to the user as a user specific event package.

In addition, some systems may require a user to select events and/or benefits from a single venue. The disclosed system can communicate with multiple event management systems related to multiple venues. In this way, the system can allocate related resources from different venues managed by multiple event management systems. For example, a user may wish to obtain access to both home and away games by the same team, multiple performances by the same artist at different venues, access to similar events across multiple museums, etc. The disclosed system is configured to store venue data for multiple venues. The system can then use conditional commands to suggest events to a user that are of a related type, but that are completely uncorrelated from a venue perspective. In this way, the disclosed system can store and provide access to data in a manner that is not otherwise possible. Further, the system is configured to provide access to groupings of data that are not available from any other single source.

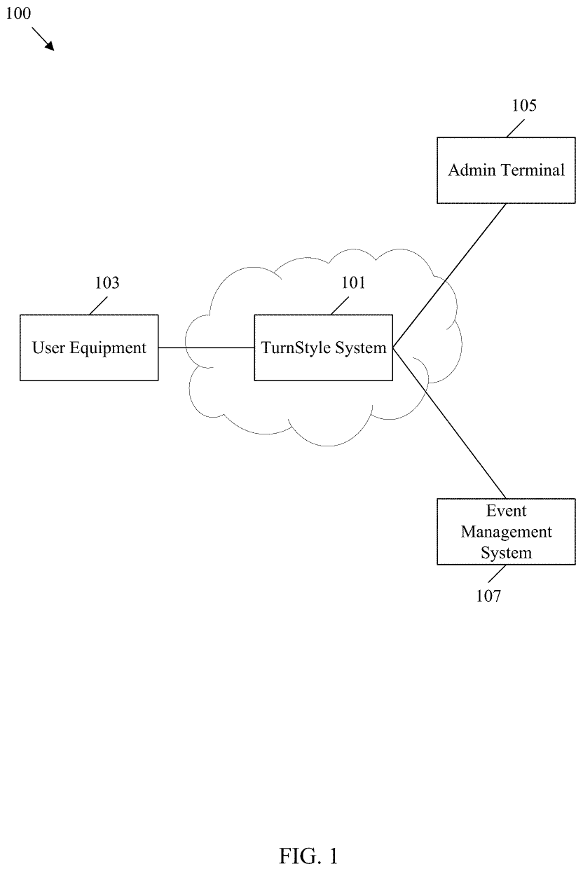

FIG. 1 is a schematic diagram of an example network 100 configured to support automated generation of event packages based on conditional commands. The network comprises a user equipment 103, an administrator terminal 105, an event management system 107, and a TurnStyle system 101.

A user equipment (UE) 103 is any user device capable of communicating over the Internet. For example, the UE 103 may comprise a personal computer, a smart phone, a tablet, or other network capable device. The UE 103 is capable of communicating with the TurnStyle system 101. For example, the UE 103 is configured to transmit packets to, and receive packets from, the TurnStyle system 101. For example, the UE 103 is configured to receive input from a user indicating user interest and other interactions and transmit packets indicating such user interest and interactions to the TurnStyle system 101. Further, the UE 103 is configured to receive indications of allocable event resources, corresponding suggestions, and selections of allocable event resources. The UE 103 is also configured to illustrate such items to the user via visualizations forwarded to a display, for example via a web browser. It should be noted that many users use the functionality of network 100, and hence many different UEs 103 may connect to the TurnStyle system 101.

An administrator terminal 105 is also a user device capable of communicating over the Internet. The administrator terminal 105 is substantially similar to a UE 103, but is used by an administrator instead of a user. The administrator terminal 105 is configured to receive and display logical operators, data points, and function calls received from the TurnStyle system 101. The administrator terminal 105 can construct conditional commands using the logical operators, data points, and function calls based on input from the user. The administrator terminal 105 can also communicate with the TurnStyle system 101, for example over the Internet, to indicate the conditional commands created by the user. For example, the administrator terminal 105 can allow an administrator to employ a web browser to create conditional commands and upload such commands to the TurnStyle system 101 for use in building event packages based on communications from users via the UE(s) 103.

An event management system 107 is a repository of venue data. The event management system 107 is configured with allocable event resources, such as events held at a venue, benefits available at events, and/or available admission areas (e.g., seats in sections) in the venue. The event management system 107 may be a server or a plurality of servers operating in a data center, for example as a virtual server in a cloud network. The event management system 107 is configured to communicate with the TurnStyle system 101 via the Internet, for example via application programming interface (API) calls. For example, the TurnStyle system 101 may query the event management system 107 to determine allocable event resources. The event management system 107 may return indications of such allocable event resources. Further, the event management system 107 may allocate such allocable event resources to a user of a UE 103 based on a request to perform such an allocation by the TurnStyle system 101. It should be noted that the TurnStyle system 101 may be configured to simultaneously obtain allocable event resources related to different events from many event management systems 107. Hence, network 100 may include a plurality of event management systems 107, depending on the example.

The TurnStyle system 101 may be a dedicated server or a plurality of servers operating in a data center, for example as a virtual server in a cloud network. The TurnStyle system 101 is configured to communicate with the UE 103, the administrator terminal 105, and the event management system 107, for example via the Internet. In an example, the TurnStyle system 101 may be configured to query and receive static data points indicating allocable event resources and dynamic data points indicating user states. The TurnStyle system 101 can provide the data points, function calls, and logical operators to the administrator terminal 105. The TurnStyle system 101 can also receive conditional commands describing event package options from the administrator terminal 105. The conditional commands may be constructed based on the data points, function calls, and logical operators provided to the administrator terminal 105. The TurnStyle system 101 can then continuously execute the conditional commands. In this way, when a current user state meets a threshold of allocable event resources as indicated by a logical operator, one or more function calls can be triggered to suggest additional allocable resources to a user and/or unlock available allocable resources for a user. As such, TurnStyle system 101 may employ the conditional commands created by the administrator terminal 105 to build the event packages based on user information from the user equipment 103 and allocate user specific event packages by requesting such allocations by the event management system 107.

The TurnStyle system 101 includes network resources, such as a transmitter and a receiver, and computational resources such as processors and memory to process and store data. For example, the TurnStyle system 101 may be configured to obtain and store allocable event resources. In this example, the TurnStyle system 101 may execute the conditional commands using the stored allocable event resources and request allocation of such resources by the event management system. This example may require that the event management system 107 set aside a block of allocable event resources for exclusive use by the TurnStyle system 101. In another example, the TurnStyle system 101 may query the event management system 107 as part of package generation to ensure that the allocable event resources suggested to a user are still available and have not been reserved by some other unrelated system. Example implementations of methods for generating user specific event packages by TurnStyle system 101 are described below.

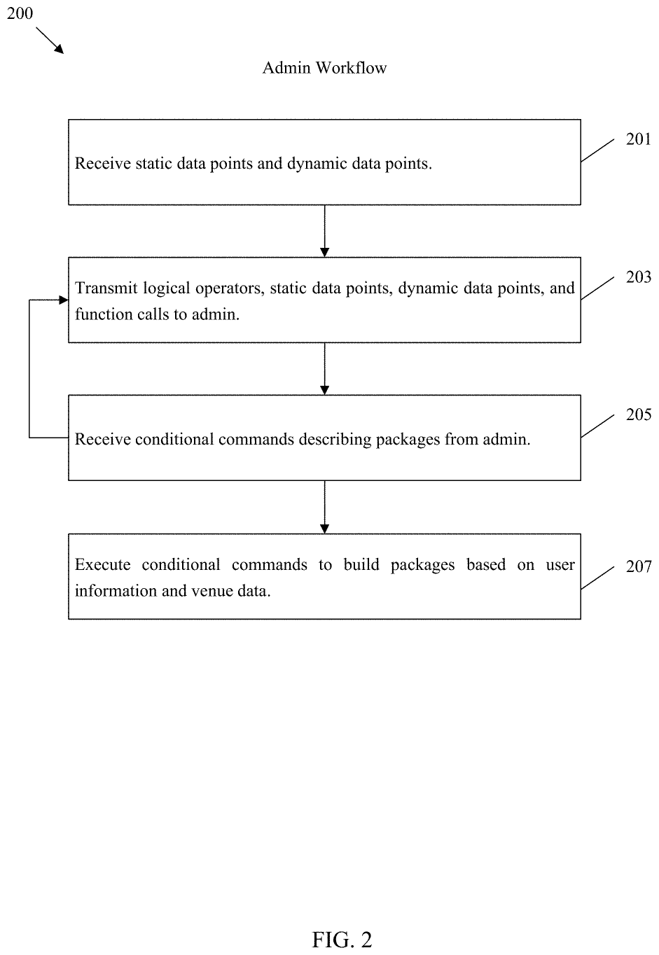

FIG. 2 is a schematic diagram of an example method 200 of generating conditional commands to support package generation. For example, method 200 can be implemented by a TurnStyle system 101 based on communication with an administrator terminal 105 and/or an event management system 107. At step 201, the TurnStyle system receives a plurality of data points. For example, the data points may be imported from an event management system into the TurnStyle system. Such data points may include static data points and dynamic data points. The static data points may indicate allocable event resources. For example, the static data points may indicate events, admission areas, benefits, and any other item that can be allocated to a particular user. The dynamic data points may indicate user states. For example, the dynamic data points may indicate potential combinations of items allocated to a user, dates related to a user, or other variable conditions that may describe a user's state. In this way, the dynamic data points may act as variables that can be applied to a user and the static data points may act as thresholds that can be compared to the variables to trigger functionality.

At step 203, the TurnStyle system can transmit indications of logical operators, the plurality of data points, and function calls to an administrator via the administrator terminal. The logical operators may be any item used to compare one or more static data points to one or more dynamic data points. For example, the logical operators may include logical and/or mathematical functions, such as and, or, not, exclusive or, greater than, less than, plus, minus, multiple, divide, etc. The function calls may include commands used to generate a user specific event package, such as lock items, unlock items, display messages, request user input, allocate resources, deallocate resources, etc. As a specific example, the function calls may include a command to unlock an allocable event resource for allocation. As another specific example, the function calls may include a command to suggest an allocable event resource to a user for inclusion in a user specific event package. The logical operators, data points, and function calls provide sufficient correlations to allow an administrator to create a set of conditional commands that can be used to build a package.

The TurnStyle system can receive the conditional commands from the administrator at step 205. The method 200 may return to step 203 as desired to allow the administrator to include many such conditional commands. The conditional commands include correlations between the logical operators, the data points, and the function calls. The TurnStyle system can then execute the conditional commands to build the event packages based on user information and venue data at step 207.

As an example, the conditional commands may correlate events such that a conditional command may suggest allocation of a second event for any user interested in a first event. As another example, the conditional commands may prevent allocation of a high priority event until a user has selected a predetermined number of lower priority events. As another example, the conditional commands may lock a second high priority event when a user has already selected a first high priority event. As another example, the conditional commands may lock and/or unlock benefits based on user selected events. As another example, the conditional commands may lock and/or unlock access to admission areas, such as sections, seats, etc., based on user selected events. As another example, the conditional commands may lock and/or unlock benefits based on selected admission areas or vice versa. As another example, the conditional commands may suggest to a user that selecting additional items cause other items to unlock and become available for selection. As another example, the conditional commands may automatically allocate items to a user when the user selects correlated items. As another example, the conditional commands may automatically deallocate an item from a user when the user selects a mutually exclusive item, for example due to conflicting schedule times accounting for travel distance between event. The preceding list should be considered to be exemplary and not limiting. As can be seen, a broad range of functionality can be created to allow for the generation of a user specific event package that is highly tailored to the user. The conditional commands can be highly tailored based on a user's expected desires as well as based on a venue's desire to prioritize allocation of certain resources. Hence, the usage of many such conditional commands may results in a highly specific user event package that is not prescribed by either the venue or the administrator and is instead generated based on user interaction. The building of such a package is discussed in greater detail with respect to method 300 below.

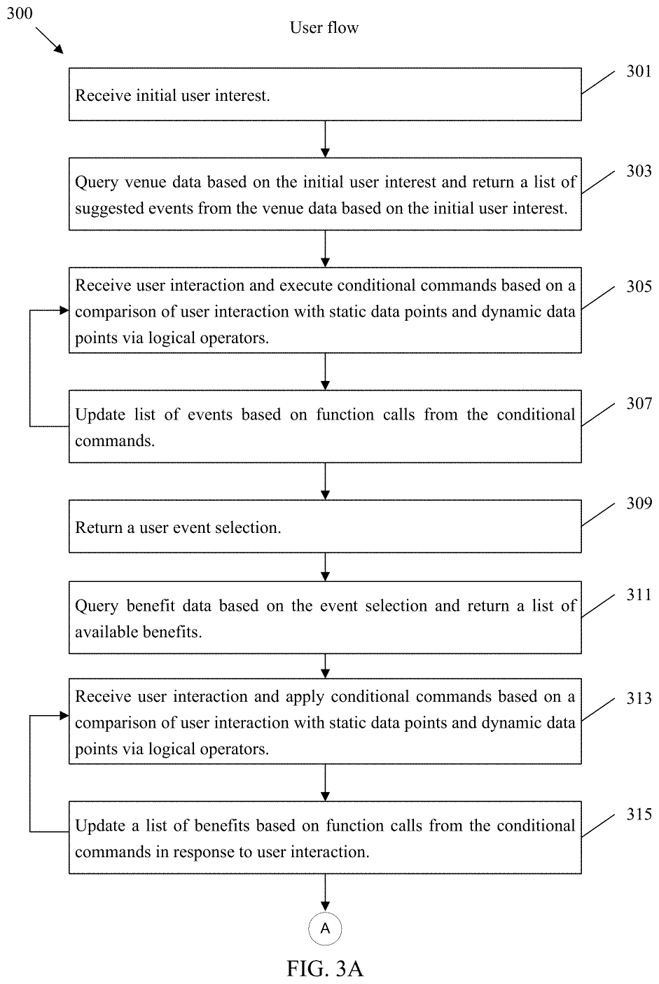

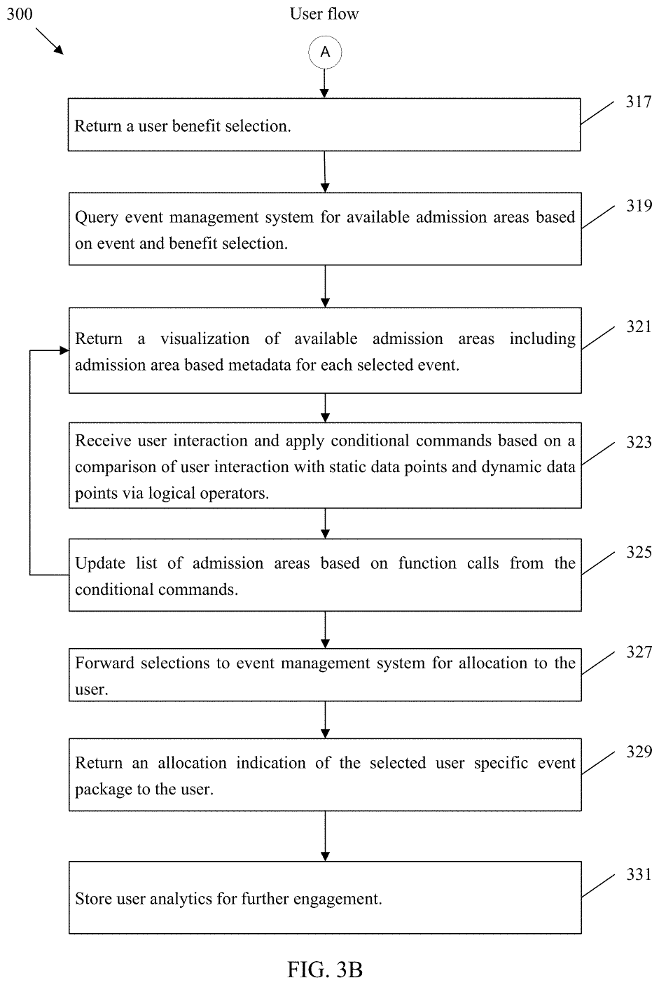

FIGS. 3A-3B are a schematic diagram of an example method 300 of generating packages based on conditional commands. Method 300 can be used in conjunction with method 200. For example, method 300 can generate a user specific event package based on the conditional commands created by an administrator in method 200. Further, the method 300 can be implemented by a TurnStyle system 101 based on communication with a UE 103 and/or an event management system 107.

At step 301 in FIG. 3A, the TurnStyle system receives an initial user interest. For example, the user may select a hyperlink on a web browser, which directs the user to a website served by the TurnStyle system. The initial user interest may comprise information sent to the TurnStyle system as part of a hypertext transfer protocol (HTTP) based communication, such as a HTTP post, a HTTP get, a HTTP put, etc. The initial user interest may, for example, indicate the user is interested in one or more events at a venue.

At step 303, the TurnStyle system queries venue data based on the initial user interest received at step 301. The venue data may be stored in memory on the TurnStyle system, in memory at one or more event management systems, or both. In an example, the venue data may include available events, which are events with available admission that are scheduled to be hosted at a venue managed by the event management system. The TurnStyle system can then return a list of available and/or suggested events from the venue data based on the initial user interest. A suggested event is an available event that is relevant to the user based on user information. For example, the TurnStyle system may return all available events at the venue(s) or may use conditional commands to reduce the results to the events that are most relevant to the user's initial interest and return such results as suggested events. For example, the events may be sorted into event types, such as types of sporting events, charity events, museum events, music events, etc. The TurnStyle system may only suggest events of the same type as indicated in the initial user interest.

At step 305, the TurnStyle system receives additional user interactions. For example, the user may begin to select various available and/or suggested events via HTTP communications. The TurnStyle system may then execute the conditional commands based on a comparison of user interaction with static data points and dynamic data points via logical operators. The TurnStyle system may update the list of suggested events based on the function calls executed as part of the conditional commands at step 307. As a specific example, the list of suggested events may include less than all available events. For example, some events may be higher priority than others. The TurnStyle system may unlock higher priority events for allocation as suggested events after a user has selected enough lower priority events. In another example, the TurnStyle system may lock conflicting events, and hence remove some events from the suggested events when other events have been selected. For example, a user attending a first event scheduled for a first start time may be unable to finish the first event and transport themselves to a second event prior to a scheduled second start time for the second event. In such case, the conditional commands may remove the second event from the suggested events when the first event is selected. As another example, the TurnStyle system may continue to add additional events to the suggested events based on relevance to the users changing selections. As another example, the conditional commands may suggest events that have other synergies with the selected events (e.g., package deals). As such, the TurnStyle system may update the list of suggested events by indicating one or more additional events are available in conjunction with a change in a current user event selection. This allows the TurnStyle system to use the conditional commands to generate a highly customized user specific event package based on the user's event selections.

The TurnStyle system may continue to receive user interaction and update the list of suggested events based on the user interaction until the user indicates that event selection is complete. At step 309, the TurnStyle system may return a user event selection as part of a user specific event package.

At step 311, the TurnStyle system may transition to benefit selection. The TurnStyle system may query benefit data based on a user event selection. The TurnStyle system can then return a list of available and/or suggested benefits based on the user event selection and the benefit data. Benefit data may include benefits and may be stored on the TurnStyle system and/or an event management system. Benefits may be various items available to a user that attends an event. Such benefits may include physical items like team jerseys, access to venue owned hardware (e.g., museum headphones for guided tours), consumable items (e.g., food, drink, etc.), venue merchandise, etc. The benefits may also include experiential items, such as access to performers, athletes, artists or other performers related to an event, access to premium services, or other event add ons. As with event selection, the TurnStyle system may return all benefits available at events selected or return suggested benefits based on current selections by employing conditional commands. For example, more premium benefits may be suggested when more events are selected.

At step 313, the TurnStyle system receives additional user interactions. For example, the user may begin to select various available and/or suggested benefits via HTTP communications. The TurnStyle system may then execute the conditional commands based on a comparison of user interaction with static data points and dynamic data points via logical operators. The TurnStyle system may update the list of suggested benefits based on the function calls executed as part of the conditional commands at step 315. As a specific example, the list of suggested benefits may include less than all available benefits. For example, some benefits may be higher priority than others. The TurnStyle system may unlock higher priority benefits for allocation as suggested benefits after a user has selected enough lower priority benefits, enough events, or combinations thereof. In another example, the TurnStyle system may lock conflicting benefits, and hence remove some benefits from the suggested benefits when conflicting benefits and/or conflicting events have been selected. For example, some benefits may include other benefits and selection of both would be redundant. Hence, the conditional commands may remove the redundant benefits. Further, some benefits may be available at some events and not others, and hence benefits may be removed by the conditional commands when corresponding events are removed by the user. As another example, the TurnStyle system may continue to add additional benefits to the suggested benefits based on relevance to the users changing selections. As another example, the conditional commands may suggest benefits that have other synergies with the selected events and/or benefits (e.g., package deals). As such, the TurnStyle system may update the list of suggested benefits by indicating one or more additional benefits are available in conjunction with a change in a current user event and/or benefit selection. This allows the TurnStyle system to use the conditional commands to generate a highly customized user specific event package based on the user's benefit selections.

The TurnStyle system may continue to receive user interaction and update the list of suggested benefits based on the user interaction until the user indicates that benefit selection is complete. At step 317 in FIG. 3B, the TurnStyle system may return a user benefit selection as part of a user specific event package.

At step 319, the TurnStyle system may transition to an admission area selection. An admission area is a portion of a venue that is allocated for exclusive use or limited shared use by the user. For example, the admission area may include a room, a section, and/or a seat at a venue for the duration of a corresponding event. It should be noted that some events may have a plurality of start times for different groups, and hence the admission area may also include an allocated start time and/or end time. The TurnStyle system may query available admission areas from venue data based on a user event selection and/or benefit selection. The TurnStyle system may then return available admission areas to the user for each selected event at step 321. In some examples, the TurnStyle system may return a visualization of the available admission areas based on the user event and/or benefit selection. For example, the TurnStyle system may store a graphical representation of the venue and may illustrate available admission areas on the graphical representation prior to forwarding such an illustration to the user (e.g., via HTTP commands). In some examples, the TurnStyle system may store various metadata related to admission areas, for example by indicating handicapped accessible areas, areas with better views, areas with better access to amenities, etc. The TurnStyle system may include graphical representations of such metadata on the admission area visualization. Hence, the visualization of the available admission areas may include indications of admission area characteristics based on admission area metadata. In some examples, all available admission areas at an event are shown. In other examples, the conditional commands may be used to suggest a specific admission area or areas based on user information (e.g., the best admission area based on the user's previous selections). In another example, the user may indicate that a plurality of admissions areas (e.g. seats) are desired, and the conditional commands may suggest contiguous admission areas so that multiple individuals may be placed together at the event.

At step 323, the TurnStyle system receives additional user interactions. For example, the user may begin to select various available and/or suggested admission areas via HTTP communications. The TurnStyle system may then execute the conditional commands based on a comparison of user interaction with static data points and dynamic data points via logical operators. The TurnStyle system may update the list of suggested and/or available admission areas based on the function calls executed as part of the conditional commands at step 325. As a specific example, the list of suggested admission areas may include less than all available admission areas. For example, some admission areas may be higher priority than others. The TurnStyle system may unlock higher priority admission areas for allocation as suggested admission areas after a user has selected enough benefits, enough events, or combinations thereof. In another example, selecting higher priority admission areas may unlock additional events and/or benefits. The conditional commands may prompt the user to select higher priority items (e.g., events, benefits, and/or admission areas) to increase other available higher priority items (e.g., events, benefits, and/or admission areas). In an example, the TurnStyle system may lock conflicting admission areas, and hence remove admission areas from the suggested admission areas when conflicting admission areas and/or conflicting events have been selected. For example, some admission areas may not be available for all events. Hence, the conditional commands may remove the unavailable admission areas. As another example, the TurnStyle system may continue to add additional admission areas to the suggested admission areas based on relevance to the users changing selections. As another example, the conditional commands may suggest admission areas that have other synergies with the selected admission areas, events, and/or benefits (e.g., package deals). In addition, the TurnStyle system may indicate a change in the type of admission area (e.g., section) at a first event may unlock and/or lock a different type of admission area at a second event. For example, a user may be allowed to select lower priority admission areas at some events and higher priority admission areas at other events for a similar aggregate value. As such, the TurnStyle system may update the list of suggested admission areas by indicating an additional admission area type is available in conjunction with a change in a current user admission area selection. This allows the TurnStyle system to use the conditional commands to generate a highly customized user specific event package based on the user's admission selections.

It should be noted that event selection, benefit selection, and admission area selection may be interrelated when creating a package. Accordingly, the selection order is customizable, and the order shown is exemplary. For example, some implementations may perform admission area selection prior to benefit selection when benefit selection is highly dependent on admission area selection. Further, the conditional commands may suggest to/allow a user to change the order of steps and/or revisit previous steps. For example, when an increase in event count would unlock additional admission areas and/or benefits, the conditional commands may allow a user to add more events during the benefit and/or admission area selection.

At step 327, the user has selected events, benefits, and admission areas which finalizes a user specific event package. Hence, the TurnStyle system may transmit one or more requests to an event management system to allocate a user event selection, a user benefit selection, and a user admission area selection. The events, benefits, and/or admission areas may be mostly uncorrelated in the event management system. As such, the TurnStyle system may request the allocation of such items individually and/or in small groups to allocate the entire user specific event package.

At step 329, the TurnStyle system can return an indication to the user to indicate the user specific event package has been allocated along with any corresponding proof, tickets, receipts etc. The indication may display the allocation as a package and may mask the individual allocations made by the event management system to create a better user experience.

At step 331, the TurnStyle system can store user analytics describing user use of the TurnStyle system during package creation and/or other user information for use in further engagement. For example, the user analytics may be used as user information and used by the conditional commands when suggesting events, benefits, and/or admission areas in subsequent applications of method 300. As another example, the TurnStyle system may save user analytics and use them to reengage with the user at a subsequent time. For example, the user analytics may indicate the types of events and/or benefits obtained by the user. At a later time, a similar type of event and/or benefit can be added to the event management system and downloaded to the TurnStyle system. When this occurs, the TurnStyle system can use the conditional commands to automatically contact the user to indicate the availability of the event and/or benefit that is of a similar type that has already been allocated to the user. In this way, the TurnStyle system can indicate to the user to reengage with the system and return to method 300 for further allocation.

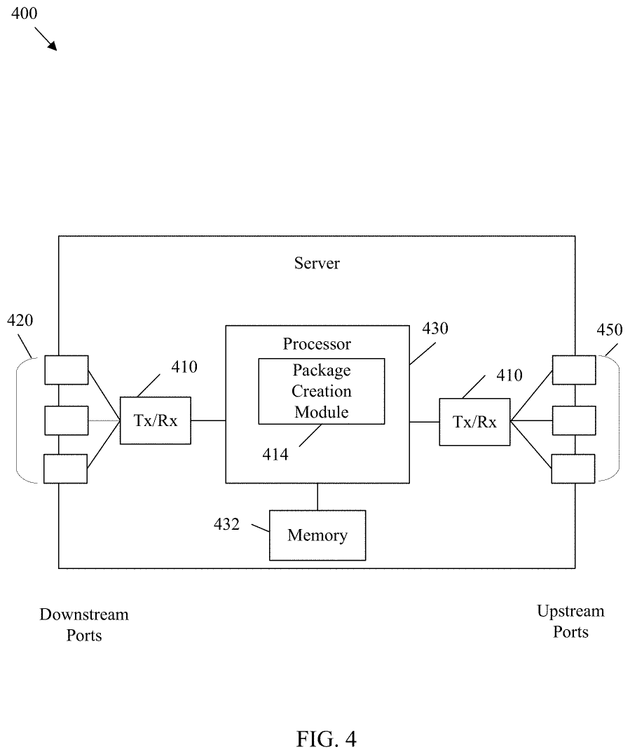

FIG. 4 is a schematic diagram of an example server 400 for operation in a network, such as a node in network 100. For example, server 200 can be employed to implement a TurnStyle system 101, an event management system 107, an administrator terminal 105, and/or a UE 103. Further, the server 400 can be used to implement method 200 and/or 300. Hence, the network node 400 is suitable for implementing the disclosed examples/embodiments as described herein. The network node 400 comprises communication circuitry, namely, downstream ports 420, upstream ports 450, and/or transceiver units (Tx/Rx) 410, including transmitters and/or receivers for communicating data upstream and/or downstream over a network. The network node 400 also includes a processor 430 including a logic unit and/or central processing unit (CPU) to process the data and a memory 432 for storing the data. The network node 400 may also comprise optical-to-electrical (OE) components, electrical-to-optical (EO) components, and/or wireless communication components coupled to the upstream ports 450 and/or downstream ports 420 for communication of data via electrical, optical, and/or wireless communication networks.

The processor 430 is implemented by hardware and software. The processor 430 may be implemented as one or more CPU chips, cores (e.g., as a multi-core processor), field-programmable gate arrays (FPGAs), application specific integrated circuits (ASICs), and digital signal processors (DSPs) or a combination of these elements. The processor 430 is in communication with the downstream ports 420, Tx/Rx 410, upstream ports 450, and memory 432. The processor 430 comprises a package creation module 414. The package creation module 414 implements the disclosed embodiments described herein. Specifically, the package creation module 414 may be used to generate, store, and execute conditional commands according to method 200 and/or create packages based on such conditional commands according to method 300. Accordingly, the package creation module 414 may be configured to perform mechanisms to address one or more of the problems discussed above. As such, the package creation module 414 improves the functionality of the network node 400 as well as addresses problems that are specific to the network communication arts. Further, the package creation module 414 effects a transformation of the network node 400 to a different state. Alternatively, the package creation module 414 can be implemented as instructions stored in the memory 432 and executed by the processor 430 (e.g., as a computer program product stored on a non-transitory medium).

The memory 432 comprises one or more memory types such as disks, tape drives, solid-state drives, read only memory (ROM), random access memory (RAM), flash memory, ternary content-addressable memory (TCAM), static random-access memory (SRAM), etc. The memory 432 may be used as an over-flow data storage device, to store programs when such programs are selected for execution, and to store instructions and data that are read during program execution.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

It should also be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A method implemented by a server, the method comprising:
receiving a plurality of data points;
transmitting indications of logical operators, the plurality of data points, and function calls to an administrator;
receiving conditional commands describing event packages from the administrator, the conditional commands including correlations between the logical operators, the data points, and the function calls; and
executing the conditional commands to build the event packages based on user information.

2. The method of claim 1, wherein the plurality of data points include static data points indicating allocable event resources.

3. The method of claim 1, wherein the plurality of data points include dynamic data points indicating user states.

4. The method of claim 1, wherein the function calls include a command to unlock an allocable event resource for allocation.

5. The method of claim 1, wherein the function calls include a command to suggest an allocable event resource to a user for inclusion in a user specific event package.

6. The method of claim 1, wherein the user information comprises an initial user interest, and further comprising:
receiving the initial user interest;
querying venue data based on the initial user interest; and
returning a list of suggested events from the venue data based on the initial user interest.

7. The method of claim 6, wherein the user information further comprises user interaction, and further comprising:
receiving the user interaction;
updating the list of suggested events based on function calls executed as part of the conditional commands; and
returning a user event selection as part of a user specific event package.

8. The method of claim 7, wherein updating the list of suggested events includes indicating an additional event is available in conjunction with a change in a current user event selection.

9. The method of claim 1, further comprising:
querying benefit data based on a user event selection; and
returning a list of suggested benefits based on the user event selection and the benefit data.

10. The method of claim 9, further comprising:
receiving user interaction;
updating the list of suggested benefits based on function calls executed as part of the conditional commands; and
returning a user benefit selection as part of a user specific event package.

11. The method of claim 10, wherein updating the list of suggested benefits includes indicating an additional benefit is available in conjunction with a change in a current user benefit selection.

12. The method of claim 1, further comprising:
querying available admission areas from venue data based on a user event selection; and
returning a visualization of the available admission areas based on the user event selection.

13. The method of claim 12, wherein the visualization of the available admission areas includes indications of admission area characteristics based on admission area metadata.

14. The method of claim 12, further comprising:
receiving user interaction;
updating the available admission areas based on function calls executed as part of the conditional commands; and
returning a user admission area selection as part of a user specific event package.

15. The method of claim 14, wherein updating the available admission areas includes indicating an additional admission area type is available in conjunction with a change in a current user admission area selection.

16. The method of claim 1, further comprising:
transmitting one or more requests to an event management system to allocate a user event selection, a user benefit selection, and a user admission area selection; and
returning an indication of an allocation of a user specific event package.

17. A server comprising:
a transmitter configured to transmit indications of logical operators, a plurality of data points, and function calls to an administrator;
a receiver configured to:
receive the plurality of data points; and
receive conditional commands describing event packages from the administrator, the conditional commands including correlations between the logical operators, the data points, and the function calls; and
a processor coupled to the transmitter and receiver, the processor configured to execute the conditional commands to build the event packages based on user information.

18. The server of claim 17, wherein the user information comprises an initial user interest and user interaction;
wherein the receiver is further configured to:
receive the initial user interest; and
receive the user interaction;
wherein the processor is further configured to:
query venue data based on the initial user interest; and
update a list of suggested events based on function calls executed as part of the conditional commands; and
wherein the transmitter is further configured to:
return the list of suggested events from the venue data based on the initial user interest; and
return a user event selection as part of a user specific event package.

19. The server of claim 18, wherein the receiver is further configured to receive user interaction;
wherein the processor is further configured to:
query benefit data based on a user event selection; and
update a list of suggested benefits based on function calls executed as part of the conditional commands; and
wherein the transmitter is further configured to:
return the list of suggested benefits based on the user event selection and the benefit data; and
return a user benefit selection as part of a user specific event package.

20. The server of claim 19, wherein the receiver is further configured to receive user interaction;
wherein the processor is further configured to:
query available admission areas from venue data based on a user event selection; and
update the available admission areas based on function calls executed as part of the conditional commands; and
wherein the transmitter is further configured to:
return a visualization of the available admission areas based on the user event selection; and
return a user admission area selection as part of a user specific event package.
